(19) United States
(12) Patent Application Publication
(10) Pub. No.: US 2026/0142737 A1
(43) Pub. Date: May 21, 2026

(54) SYSTEMS AND METHODS FOR INTER-TOOL SYNCHRONIZATION

(71) Applicant: Schlumberger Technology Corporation, Sugar Land, TX (US)

(72) Inventors: Desheng Zhang, Sugar Land, TX (US); Robert Tennent, Katy, TX (US)

(21) Appl. No.: 19/263,768

(22) Filed: Jul. 9, 2025

Related U.S. Application Data
(60) Provisional application No. 63/721,276, filed on Nov. 15, 2024.

(51) Int. Cl. H04J 3/06; H04L 27/06

(52) U.S. Cl. CPC H04J 3/0644; H04L 27/06

(57) ABSTRACT

A method includes transmitting the hybrid timing signal, via a master clock, to the local clock of the tool, wherein the hybrid timing signal comprises one or more wide-band signal sections and one or more narrowband signal sections. The method also includes calculating an initial clock offset between the local clock of the tool and the master clock, based on a difference in the time of arrival and the hybrid timing signal at the local clock and a time of transmission of the hybrid timing signal and synchronizing the tool based on the initial clock offset.

### CROSS-REFERENCE TO RELATED APPLICATIONS

This application claims priority to and benefit of U.S. Provisional Patent Application No. 63/721,276, filed on Nov. 15, 2024, which is incorporated by reference herein in its entirety.

### BACKGROUND

The present disclosure generally relates to systems and methods for inter-tool synchronization in an oil and gas production system. More specifically, the present disclosure is directed to implementing wide-band signals with single-tone signals to improve inter-tool synchronization of tools within a wellbore.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Exploration and characterization of environments via downhole drilling tools has been widely used in industry and scientific applications, including, but not limited to, space exploration, mining, civil engineering, geothermal, and oil and gas. Data collected during exploration and characterization of said environments provides information to direct further exploration and characterization in near real-time or subsequent to initial explorations. For example, solids may be imaged using digital images or three-dimensional (3D) images from a laser scanner or resistivity measurements may provide information related to drilling conditions. Further, additional properties such as petrophysical properties, reservoir characteristics, and the like may be extracted to direct drilling processes.

Synchronization of devices is used to ensure downhole drilling systems operate properly, provide reliable and accurate data, and operate on functional timescales. Synchronization techniques of various devices of downhole drilling systems operate to align times of one or more local clocks included in downhole drilling systems to a master clock. Previously available synchronization techniques align local clocks to the master clock by transmitting a synchronization timing signal from the master clock to various local clocks to acquire and determine a signal arrival time at the local clocks based on a time offset and a clock discrepancy. The time offset may be determined by comparing the difference between a transmission time of the master clock and a reception time at the various local clocks. The clock discrepancy may be determined by measuring differences in elapsed time of the transmission time of the master clock and the reception time at the various local clocks at least two synchronization events. Conventional synchronization of devices assumes the various local clocks can accurately determine the signal arrival. However, phase banding of timing signals may occur impacting accuracy in determining signal arrival time. As such, there is a need to reduce phase-banding and improve device synchronization.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes transmitting the hybrid timing signal, via a master clock, to the local clock of the tool, wherein the hybrid timing signal comprises one or more wide-band signal sections and one or more narrowband signal sections. The method also includes calculating an initial clock offset between the local clock of the tool and the master clock, based on a difference in the time of arrival and the hybrid timing signal at the local clock and a time of transmission of the hybrid timing signal and synchronizing the tool based on the initial clock offset.

In certain embodiments, a non-transitory, computer-readable storage medium, including processor-executable routines that, when executed by a processor, cause the processor to perform operations including transmitting the hybrid timing signal, via a master clock, to the local clock of the tool, wherein the hybrid timing signal comprises one or more wide-band signal sections and one or more narrowband signal sections. The operations also include determining a time of arrival of the hybrid timing signal at the local clock based on a cross-correlation and a phase estimate, wherein the cross-correlation is generated between the wide-band signal section of the hybrid timing signal and a reference signal, determining a mean path delay of the hybrid timing signal, calculating an initial clock offset between the local clock of the tool and the master clock, based on a difference in the time of arrival and the hybrid timing signal at the local clock and a time of transmission of the hybrid timing signal and synchronizing the tool based on the initial clock offset.

In certain embodiments, a system is provided including processing circuitry and memory, accessible by the processing circuitry, the memory storing instructions that, when executed by the processing circuitry, cause the processing circuitry to perform operations. The operations include transmitting the hybrid timing signal, via a master clock, to the local clock of the tool, wherein the hybrid timing signal comprises one or more wide-band signal sections and one or more narrowband signal sections. The operations also include calculating an initial clock offset between the local clock of the tool and the master clock, based on a difference in the time of arrival and the hybrid timing signal at the local clock and a time of transmission of the hybrid timing signal and synchronizing the tool based on the initial clock offset.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating a drilling system including a synchronization system and a control system, in accordance with an embodiment of the present disclosure;

FIG. 2A is a block diagram of a first LWD module and a second LWD module including one or more timing modules connected to a tool bus via a wired connection;

FIG. 2B FIG. 2A is a block diagram of a first LWD module and a second LWD module including one or more timing modules connected via a wireless connection;

FIG. 3 is a flow chart of an embodiment of a process for providing near real-time synchronization measurements within a wellbore and adjusting operation of a drilling system based on time synchronization, in accordance with the present disclosure;

FIG. 4 is a flow chart of an embodiment of a process for generating a hybrid timing signal and determining a synchronization correction between a master clock and one or more local clocks, in accordance with the present disclosure;

FIG. 5 illustrates a timing signal scheme including one or more signal bursts related to an embodiment of the hybrid timing signal, in accordance with the present disclosure;

FIG. 6 illustrates a timing signal scheme including one or more hybrid timing signal bursts in the time domain and the frequency domain, in accordance with the present disclosure;

FIG. 7 is an embodiment of a method of generating a fine timing estimate of a TOA by estimating the phase of a narrowband signal section of a hybrid timing signal;

FIG. 8 is a flow chart of a computer-implemented method or process for calculating an initial clock offset between a master clock and a local clock, in accordance with the present disclosure;

FIG. 9 illustrates a graph of phase versus time offset for a sinusoidal tone with three samples per carrier cycle, in accordance with the present disclosure;

FIG. 10 illustrates a precision time protocol including a plurality of timing pulses and a plurality of message passings, in accordance with the present disclosure; and

FIG. 11 is an embodiment of a user interface of synchronization system, wherein the user interface is disposed on an electronic device, in accordance with the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the term “processing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM).

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed continuously and/or automatically in substantially real time during operation of the computing system and/or equipment controlled by the computing system, it will be appreciated that these operations may, in fact, be performed continuously and/or automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As described above, data may be collected via various devices during exploration of earth formations. Logging while drilling (LWD) modules and measurement while drilling (MWD) modules may be used to collect various types of data (e.g., temperature, pressure, spectral, etc.) to report on drilling conditions. Data collected by LWD modules and/or MWD modules may be used to direct drilling exploration, provide information related to characteristics of earth formations, control drilling equipment (e.g., drilling speed, weight on bit, direction of drilling via rotary steerable system, flow of mud, etc.), and the like. As various measurements may be collected simultaneously time synchronization is used to ensure data collected from various devices and/or modules is timestamped accurately and reliably. For example, a voltage measurement may be collected by a first device simultaneous to a pressure measurement by a second device. The voltage and the pressure data may be processed based on respective timestamps to map out conditions of a borehole during drilling operations. As such, there is a need to ensure timestamps of various devices are accurate and reliable. Previously available synchronization techniques align clocks local (e.g., one or more local clocks, slave clocks) of modules and/or devices to a master clock by transmitting a synchronization timing signal from the master clock to the local clocks to acquire and determine a signal arrival time at the local clocks based on a time offset and a clock discrepancy. Use of a wide-band signal as the synchronization timing signal may limit a precision in determining the signal arrival time. Alternatively, use of a single-tone signal to determine the signal arrival time may lead to phase banding of timing signals impacting accuracy in determining the signal arrival time due to lack in a designed peak in the cross-correlation function of the single-tone signal. As such, there is a need to improve device synchronization to reduce phase banding while providing high accuracy (e.g., super resolution TOA) in performance of all timing signal channel conditions. Phase banding occurs when the TOA is off by multiples (e.g., integer multiples) of a synchronization timing carrier period, An improved synchronization may also lead to efficiency improvements in a control system for the drilling equipment, and particularly improving real-time measurements and control of the drilling equipment.

Accordingly, the present disclosure techniques may be used to synchronize devices to improve accuracy of demodulation performance in timing signal channels with nonlinear and/or irregular frequency responses. A synchronization system is disclosed herein to provide time synchronization between one or more inter-tool devices (e.g., modules, tools, devices) via one or more timing modules. Time synchronization of inter-tool synchronization may improve near real-time control of drilling operations. The timing modules may be positioned within separate MWD tools and/or LWD tools. Each of the MWD tools and the LWD tools may include respective clocks. As such, the synchronization system may be used to synchronize the respective clocks of each of the MWD tools and the LWD tools to a master clock located within a bottom hole assembly (BHA).

In certain embodiments, the synchronization modules may use a hybrid timing signal (e.g., mixed timing signal) including a combination of a wide-band timing signal (e.g., bi-phase modulated pseudo-random sequence signal) and a single-tone timing signal to determine an initial clock offset between. In some embodiments, the hybrid timing signal may improve time synchronization by using the wide-band timing signal to determine a coarse time of arrival (TOA) and the single-tone timing signal to determine a super resolution time of arrival (SR-TOA). In this manner, the SR-TOA may be used in combination with a calculated frequency offset and mean path delay to calculate the initial clock offset. The initial clock offset may be calculated over time to provide near real-time measurement of the actual clock offset. In this way, the actual clock offset may be used to synchronize tools with high precision. For example, the synchronization modules described herein may be used to track changes in time synchronization due to changes in the local clocks (e.g., temperature changes, clock drift, and the like). Advantageously, disclosed techniques may improve time synchronization for measurements conducted by LWD tools, MWD tools, and the like within wellbores, thereby ensuring a more accurate evaluation of measured parameters in the wellbore and more efficient control of the drilling equipment.

In some embodiments, the hybrid timing signal (e.g., hybrid synchronization sequence) includes a wideband signal section and a narrowband signal section. The wideband signal provides a mechanism for providing a TOA estimation (e.g., the coarse TOA) at a receiving end of a channel of a sync signal. The wideband signal section may include one or more Barker sequences, a pseudo-noise (PN) sequence, a pseudo-random binary sequence (PRBS), and/or one or more additional sequences. The wideband signal section may be modulated via a modulating sequence onto a carrier wave (e.g., a sinusoidal carrier wave, a chirp signal, a sinusoidal signal with a time-varying frequency, and the like) using binary phase shifting keying (BPSK). In certain embodiments, the wideband signal section of the hybrid timing signal may be generated by modulating a sequence of binary bits, or complex-valued symbols, onto the carrier wave. In other embodiments, the wideband signal section of the hybrid timing signal may be a chirp signal, a sinusoidal signal with a time-varying frequency. The rate at which the components (e.g., chips) of the modulating sequence switch a phase of the carrier wave may determine a width of spread of signal energy on each side of frequency of the carrier wave. In some embodiments, the narrowband signal (e.g., single tone) provides a mechanism for generating a SR-TOA estimation (e.g., SR-TOA). In some embodiments, the hybrid timing signal may be generated using multi-carrier modulation. For example, multi-carrier modulation may include discrete multi-tone (DMT), orthogonal frequency division multiplexing (OFDM), and the like. The wideband signal section may be generated using a Zadoff-Chu sequence across multiple sub-carriers. The narrowband signal section may be generated by using a constant phase on a central sub-carrier of sub-carriers. The TOA estimation may be used to localize the TOA of the sync signal within one cycle of the narrowband signal. In some embodiment, the wideband signal and the narrowband signal may be modulated onto a sinusoidal carrier wave at the same frequency.

In some embodiments, the hybrid timing signal may be transmitted between one or more master clocks and one or more local clocks. In some instances, the hybrid timing signal may be transmitted by the master clocks and received by the local clocks. Additionally and/or alternatively, the hybrid timing signal may be transmitted by the local clocks and received by the master clocks. In certain embodiments, the hybrid timing signal may be transmitted based on a protocol and may be used to determine a clock offset, a clock discrepancy, a frequency offset, or a combination thereof. The hybrid timing signal may include the wide-band signal section followed by the narrowband signal section (e.g., a sinusoidal pulse at a predetermined time offset (e.g., a number of cycles) relative to the wide-band signal portion of the hybrid timing signal. The wide-band signal section and the narrowband signal section of the hybrid timing pulse may have opposite time and frequency properties. That is, the wideband signal section may have a wide bandwidth in the frequency domain, and a narrow magnitude peak in the time domain after cross-correlation with a reference waveform. The narrowband signal section may have a narrow bandwidth in the frequency domain and a broad correlation magnitude peak in the time domain. As such, the wide-band signal section may be used to estimate a TOA.

In certain embodiments, a synchronization request may be made between timing modules positioned within a tool being used within a wellbore. The hybrid timing signal may be generated and transmitted from a first clock (e.g., master clock, local clocks) to a second clock (e.g., local clock, master clocks) of a particular timing module via a carrier wave. The hybrid timing signal may be received by the second clock and a cross-correlation measurement of the received hybrid timing signal may be performed to determine the TOA of the hybrid timing signal at the second clock. In some embodiments, the received hybrid timing signal may be impacted by noise, signal distortion, clock drift, and the like. As such, the timing module may perform cross-correlation of the received hybrid timing signal with a reference waveform matched to the wide-band signal section of the hybrid timing signal. In some embodiments, an autocorrelation sequence of a modulating sequence of the carrier wave may have a single main peak when the received hybrid timing signal aligns with the reference waveform. Further, the carrier wave may have low sidelobes other time offsets (e.g., time offsets not related to the received hybrid timing signal). For example, in some instances, a length 11 binary Barker sequence may be used as a modulating sequence (e.g., generating the wideband signal section). As such, 11 chips may be present within the duration of the wideband signal section. The length 11 binary Barker sequence may have a correlation sequence with a single main peak, with a magnitude 11 times higher than the sidelobes, at other time offsets. In this manner, the null-to-null width of the single peak may be twice the chip period. The length (e.g., sequence length) of synchronization sequences may be used to determine a height of the correlation peak relative to the sidelobes. Additionally and/or alternatively, the chip period may be used to determine the correlation peak width. The higher the chip rate, the narrower the correlation peak.

In some embodiments, the cross-correlation measurement of the wide-band signal section provides the coarse TOA, as the wide-band signal has a limited number of samples per cycle of the carrier wave. However, the phase of the cross-correlation measurement may not remain linear with TOA offset. As such, the narrowband signal section may be used to provide a phase estimate of the narrowband tone to improve estimation of the TOA. For example, a coarse timing estimate of the TOA (e.g., coarse TOA) may be determined by transmitting the wideband signal section and detecting an arrival time using a correlation method that results in a narrow peak in the time domain. The coarse timing estimate may have a resolution to detect the TOA within one cycle period of the narrowband signal section that follows the wide-band signal section. Therefore, a fine timing estimate (e.g., fine time offset) may be determined by estimating a phase of the narrowband signal section. The fine time offset may determine the phase of the narrowband signal section. The phase of the narrowband signal section may be determined using a cross-correlation method. In some embodiments, the cross-correlation method may include using a pair of narrowband reference waveforms with a 90 degree phase shift (e.g., a sine tone and a cosine tone, or by a Hilbert transform) and/or by using an in-phase/quadrature mixer and averaging of the I and Q outputs of the mixer over the time period of the narrowband section. For example, in some embodiments, the phase estimate may be generated by splitting the received hybrid timing signal into an in-phase (I) and a quadrature (Q) component using a Hilbert transform or an in-phase and quadrature mixer followed by lowpass filtering. It should be noted, in the absence of a frequency offset between the transmitter and receiver clocks, the I and Q components of the narrowband tone remain constant for a duration of the narrowband signal section. In some embodiments, averaging the I and the Q components over the duration of the narrowband signal section may reduce effects of noise. As such, a four-quadrant arctangent estimate (e.g., arctan(Q/I)) may provide the phase estimate. The fine time offset may be extracted from the phase estimate.

As described herein, near-real time acquisition of the initial clock offset provide near real-time understandings of timing synchronization between tools, devices, and/or modules of a drilling system, thereby helping to improve near real-time control of the drilling system. For example, the near real-time acquisition of the time synchronization may be used to produce data that may provide direction to a control system of a drilling system to alter one or more aspects of a drilling operation, such changing a direction of drilling via a rotary steerable system (RSS), changing a speed of rotation of a drill bit, changing a flow rate of a drilling mud, controlling a pressure of the well, or any combination thereof. As a result, the synchronization system provided herein may expedite and improve hydrocarbon exploration and production operations.

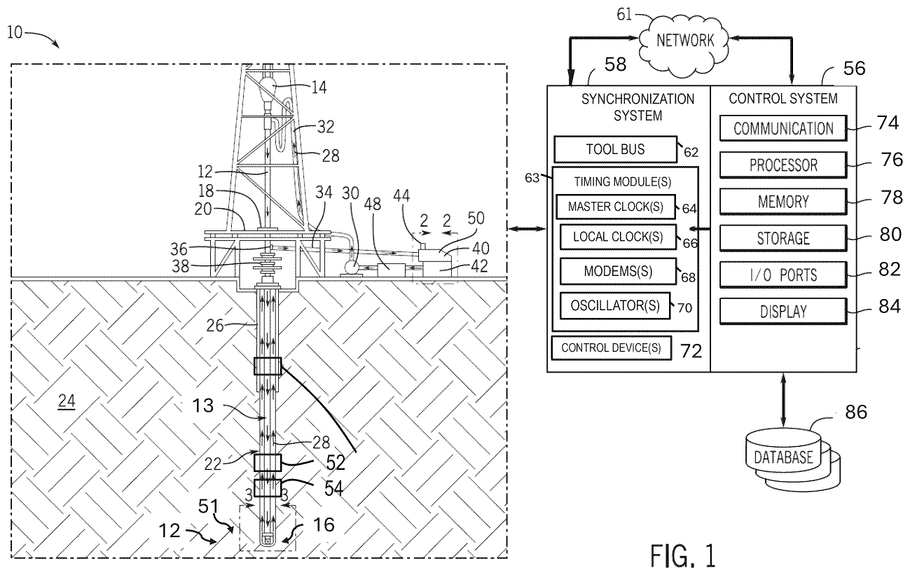

With this in mind, FIG. 1 is a schematic diagram illustrating a drilling system 10 in accordance with the embodiments described herein. As illustrated, in certain embodiments, a downhole a drill string 13 including a bottom hole assembly (BHA) 51 containing a downhole tool 12 may be suspended at an upper end by a kelly system and/or a top-drive and a traveling block 14 and terminated at a lower end by a drill bit 16. The drill string 13 and the drill bit 16 are rotated by a rotary table 18 on a driller floor 20, thereby drilling a borehole 22 (e.g., wellbore) into earth formation 24, where a portion of the borehole 22 may be cased by a casing 26. As illustrated, in certain embodiments, drilling fluid or drilling “mud” 28 may be pumped by a mud pump 30 into the upper end of the downhole tool 12 through a connecting mud line 32. From there, the drilling fluid 28 may be pumped downward through the downhole tool 12, exiting drill string 13 through an opening in the drill bit 16, and returning to the surface by way of an annulus formed between the wall of the borehole 22 and an outer diameter of the drill string 13. Once at the surface, the drilling fluid 28 may return through a return flow line 34, for example, via a bell nipple 36. As illustrated, in certain embodiments, a blowout preventer 38 may be used to prevent blowouts from occurring in the drilling system 10. As illustrated in FIG. 1, solids that are formed by the drill bit 16 crushing rocks in the earth formation 24 may typically be removed from the returned drilling fluid 28 by a shale shaker 40 in the return flow line 34 such that the drilling fluid 28 may be reused for injection, where the shale shaker 40 includes a shaker pit 42 and a gas trap 44. The drilling fluid 28 may then be delivered to a mud pit 48 from which the mud pump 30 may draw the drilling fluid 28. The shale shaker 40 may include a conveyor 50, which may be used to transfer the solids for reinjection into the borehole 22.

In some embodiments, the drill string 13 transmits the drilling fluid 28 through the borehole 22 and transmits rotational power from the kelly system and/or the top-drive to the drill bit 16. Additionally and/or alternatively, rotational power may be extracted from the drilling fluid 28 by a mud motor located near the drill bit 16. In some embodiments, the BHA 51 may include one or more logging-while-drilling tools (LWD) 52, one or more logging-while-drilling (“LWD”) tools 54, the drill bit 16, a rotary steering system (RSS), or other components. An example BHA may include additional or other components (e.g., coupled between to the drill string 13 and the drill bit 16). Examples of additional BHA components include drill collars, stabilizers, downhole motors, underreamers, section mills, hydraulic disconnects, jars, vibration or dampening tools, other components, or combinations of the foregoing downhole well tools. The drill bit 16 may also include other cutting structures in addition to or other than the drill bit 16, such as milling or underreaming tools. The RSS may include one or more apertures through which a propellant (e.g., emission, gases, etc.) is expelled to steer the drill string 31 and the BHA 37. For example, the RSS may be used to steer the drill string 13 and the BHA 51 around obstacles.

In some embodiments, the BHA 51 may include the one or more logging while drilling (LWD) modules 52, the one or more measurement while drilling (MWD) modules 54, one or more additional tools, or a combination thereof. The LWD modules 52 and/or the MWD modules 54 may collect measurements (e.g., sensor data) during operation of the drilling system 10. For example, the LWD modules 52 and/or the MWD modules 54 may obtain measurements related to resistivity, pressure, temperature, and the like during operation. In some embodiments, components of the BHA 51 such as the LWD modules 52 and/or the MWD modules 54 of the drilling system 10 may obtain downhole measurements in the borehole 22. For each depth of the borehole 22 that is measured, the LWD modules 52 and/or the MWD modules 54 may generate log data (e.g., a borehole image, density, electromagnetic measurements, and/or photoelectric factor measurements). The LWD modules 52 and/or the MWD modules 54 of the downhole tool 12 may provide such measurements to a control system 56. The control system 56 may be connected to components of the BHA 51 via any suitable telemetry (e.g., via electrical signals pulsed through the earth formation 24 or via mud pulse telemetry). In some embodiments, the downhole measurements may be sent via a telemetry system to the surface for receival and storage by a surface logging system. In other embodiments, the downhole measurements may be sent directly to the control system 56 that may receive and store downhole measurements from the BHA 51. The control system 56 and/or the surface logging system may process the measurements to identify patterns related to properties of the earth formation 24 or the borehole 22. The patterns in the measurements may indicate certain properties of the borehole 22 (e.g., formation dip, boundaries, pressures, temperatures, strain, etc.) that could be otherwise indiscernible by a human operator.

In some embodiments, components of the BHA 51 such as the LWD modules 52 and/or the MWD modules 54 of the drilling system 10 may include a synchronization system 58. The synchronization system 58 may be used to synchronize timing signals to ensure proper data collection of each component of the BHA 51 such as the LWD modules 52, the MWD modules 54, and/or one or more additional tools (e.g., modules, devices) of the drilling system 10. In some embodiments, the synchronization system 58 may include a tool bus 62, one or more timing modules 63, and one or more control devices 72. The one or more timing modules 63 may be positioned in each of the LWD modules 52, the MWD modules 54, and one or more additional tools. The timing modules 63 may include one or more master clock 64, one or more local clocks 66, one or more modems 68, one or more oscillators 70, and/or one or more additional components. In some embodiments, each of the LWD modules 52 and/or the MWD modules 54 of the BHA 51 may include a respective timing module 63. In some embodiments, one or more sub-modules of the BHA 51 may be spatially separated within the downhole tool 12. As such, the sub-modules may include one or more additional timing modules 63.

In some embodiments, the timing modules 63 of the LWD modules 52 and/or the MWD modules 54 may communicate across the tool bus 62 (e.g., inter-tool bus) or a network 61. The network 61, or parts of the network 61, may be wirelessly connected to the timing modules 63. As such, a subset of the LWD modules 52, the MWD modules 54, and/or one or more additional tools may not be coupled via a wired connection. Each of the LWD modules 52 and/or the MWD modules 54 may include a respective modem (e.g., demodulator, modulator). The modem 68 may generate and receive hybrid timing signals used during communication between tools. In some embodiments, each the LWD modules 52 and/or the MWD modules 54 and corresponding modem may include a designated local clock (e.g., a respective local clock of the local clocks 66). As such, the timing modules 63 may be positioned in each designated local clock. In this manner, the local clocks 66 may use the hybrid timing pulses, sent between tool of the BHA 51, to synchronize the local clocks 66 within each tool to the master clock 64.

In certain embodiments, one tool (e.g., one of the LWD modules 52 and/or one or the MWD modules 54) in the BHA 51 may act as a timing master (e.g., a particular master clock 64) and one or more additional of the LWD modules 52 and/or the MWD modules 54 may synchronize respective local clocks 66 (e.g., one or more local clocks housed within the one or more additional of the LWD modules 52 and/or the MWD modules 54) to the timing master. The timing master may send one or more master timing pulses, via a respective modem 68, at one or more intervals (e.g., regular intervals). The one or more additional of the LWD modules 52 and/or the MWD modules 54 use a difference in arrival times of the master timing pulses to calculate a frequency offset of each respective local clock relative to the timing master. The one or more additional of the LWD modules 52 and/or the MWD modules 54 may transmit one or more local timing pulses back to the timing master. The timing master may send a TOA message back to the one or more additional of the LWD modules 52 and/or the MWD modules 54 following the local timing pulses, in order for one or more additional of the LWD modules 52 and/or the MWD modules 54 to calculate a mean path delay.

In some embodiments, the tool bus 62 may include one or more buses to serve as a communication interface. For example, the tool bus 62 may include an inter-tool bus, a plant bus, a terminal bus, and the like. The tool bus 62 may include a wired connection between the master clock 64, the local clocks 66, one or more additional clocks, and the like. It should be noted that, in some embodiments, the master clocks 64 may be wirelessly connected to the tool bus 62. The tool bus 62 may interface with one or more components of the control system 56. That is, the tool bus 62 may facilitate communication between the master clock 64 and the local clocks 66 over the tool bus 62.

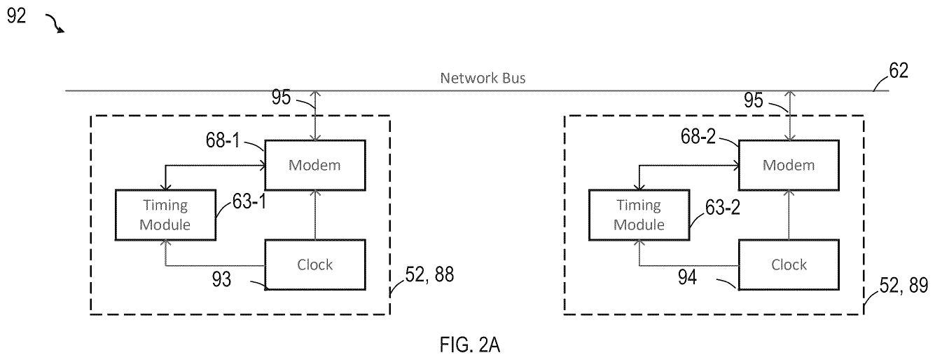

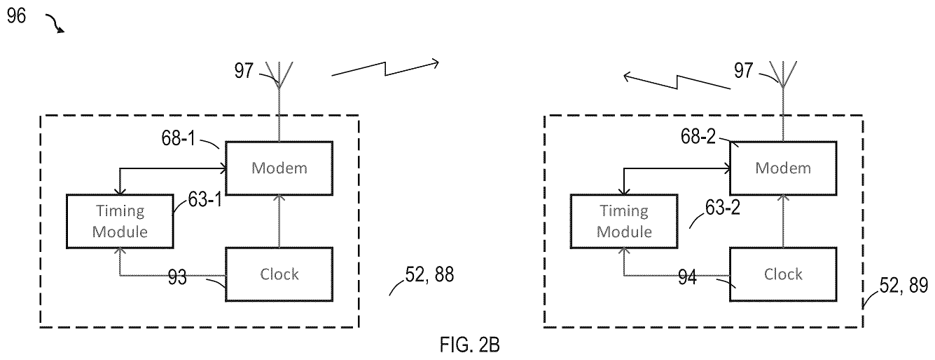

Referring now to FIG. 2A and FIG. 2B, block diagrams are illustrated including a tool bus 62 may be used to facilitate communication between a first LWD module 88 and a second LWD module 89. The first and second LWD modules 88, 89 may include a timing module 63, one or more clocks 64, 66, and a modem 68. Synchronization componentry of the LWD moules 88, 89 may be connected to the tool bus 62 via a wired connection 90 (e.g., FIG. 2A) and/or a wireless connection 91 (e.g., FIG. 2B). FIG. 2A

The first LWD module 88 may include a first timing module 63-1, a first modem 68-1, and a first clock 93 (e.g., a master clock 64 and/or a local clock 66). The second LWD module 89 may include a second timing module 63-2, a second timing module 63-2 and a first clock 94 (e.g., a master clock 64 and/or a local clock 66). Synchronization components such as the timing modules 63, the modems 68, and the clocks 93, 94 of the LWD modules 88, 89 may be wired to the tool bus 62 (e.g., a network bus) via a wired connection 95. FIG. 2B illustrates a block diagram 96 of an embodiment of the first LWD module 88 and the second LWD module 89. The first LWD module 88 may include the first timing module 63-1, the first modem 68-1, and the first clock 93 (e.g., a master clock 64 and/or a local clock 66). The second LWD module 89 may include the second timing module 63-2, the second timing module 63-2 and the first clock 94 (e.g., a master clock 64 and/or a local clock 66). The timing modules 63 may include a wireless connection 97 to the tool bus 62 (e.g., a network bus) and/or one or more additional components of the synchronization system 58. It should be noted, that one or more additional LWD modules and/or one or more MWD modules may be connected to one another via the wired connection 95, the wireless connection 97, or a combination thereof.

Returning to FIG. 1., in some embodiments, the master clock 64 may retrieve an accurate time from one or more sources. The sources may include a GPS source, a GLONASS source, a Galileo source, and the like. For example, an atomic clock may be positioned in the BHA 51. In certain embodiments, the master clocks 64 positioned in the BHA 51 may not have access to a GPS type time reference. As such, a true “absolute” reference time may not be established. Alternatively, a relative time established by a particular master clock may be used as a reference time. In some embodiments, the particular master clock may include a low drift master clock located in the BHA 51, a temperature compensated crystal oscillator (TCXO), a oven-controlled crystal oscillator (OCXO), and the like.

In some embodiments, the master clock 64 may be used to send the time synchronization signal to the local clocks 66. For example, the master clock 64 may send hybrid timing signals at periodic intervals to the local clocks 66. The local clocks 66 (e.g., slave clocks) may include one or more hardware components related to one or more modules (e.g., LWD modules 52, MWD modules 54), one or more additional tools, and the like. The local clocks 66 may be positioned within the LWD modules 52 and/or the MWD modules 54 within the tool. A clock offset, a clock discrepancy, a frequency offset, and the like of the local clocks 66 may be determined by transmitting one or more time sync signals between the master clocks 64 and the local clocks 66 as discussed below. For example, to calculate a mean path delay a particular local clock may send a hybrid timing signal to the master clock 64. In some embodiments, the modems 68 may be used to superimpose and/or encode a baseband signal onto a carrier signal. As disclosed herein, the hybrid timing signal may be modulated onto a carrier wave by modulating a wide-band signal onto the carrier wave at the same frequency as a narrowband signal. In this manner, the modems 68 may be used to generate the hybrid timing signal through modulation onto the carrier wave.

In some embodiments, the oscillators 70 may include a hardware component that may generate periodic signals referred to herein as the hardware component of the master clocks 64, the local clocks 66, or a combination thereof. It should be noted, as described herein the oscillators 70 and the clocks 64, 66 may be referred to interchangeably. The oscillators may include a crystal oscillator, a colpitts oscillator, a MEMS oscillator, an RC oscillator, one or more additional oscillators, and the like. The oscillators 70 may generate frequencies and signals used to perform time synchronization. Changes to local environments of the oscillators 70 may add noise to the signals generated by the oscillators 70, cause drift in the signals, and the like. For example, the oscillators 70 may include a quartz oscillator that may utilize the piezoelectric properties of quartz to generate a timing signal. As such, temperature, pressure, and the like may impact behavior of the generated signal of the quartz oscillator. It should be noted, oscillators 70 operated within the drilling system 10 described herein may experience increased noise and drift during operation within the borehole 22.

The control devices 72 (e.g., processor-based controller) of the synchronization system 58 may control operational conditions associated with data acquisition by the LWD modules 52, MWD modules 54, the one or more timing modules 63, and one or more data acquisition devices. For example, the control devices 72 may facilitate operation of the timing modules 63 located within downhole modules (e.g., components of the BHA 51 such as the LWD modules 52 and/or the MWD modules 54). As such, the control devices 72 may be connected by a wired or wireless network (e.g., network 61). Additionally and/or alternatively, the control devices 72 may be used to facilitate transmission of signals between the timing modules 63 and sensors located at a surface. However, it should be noted in some embodiments, the timing modules 63 may be located in separate modules positioned away from the control devices 72 (e.g., antennas, other transmitters) and may not be linked via a dedicated clock line between them. Further, the control devices 72 may be communicatively coupled to the control system 56 to provide data for further analysis, correlation, reconstruction, and/or output.

In some embodiments, the control system 56 may be any electronic data processing system that can be used to carry out the systems and methods of this disclosure. For example, the control system 56 may include communication component 74, a processor 76, memory 78, storage 80, one or more I/O ports 82, a display 84, one or more additional components, or a combination thereof. The processor 76 may be any type of computer processor or microprocessor capable of executing computer-executable code. The processor 76 may also include multiple processors that may perform the operations described below. As such, the memory 78 and/or the storage 80 of the control system 56 may be any suitable article of manufacture that can store the instructions. The memory 78 and/or the storage 80 may be ROM memory, random-access memory (RAM), flash memory, an optical storage medium, or a hard disk drive, to name a few examples.

The control system 56 may be used to receive and analyze data including timestamps generated by the synchronization system 58 directly or via a network 61. The control system 56 may be located at the oil and gas work site or at one or more remote locations. The network 61 may include transceivers, receivers, and/or transmitters to facilitate data communication to and/or from the control system 56. For example, measurement data generated by the LWD modules 52, the MWD modules 54 may be transmitted to the control system 56 through the network 61. Further, external data (e.g., data about a geologic formation) may be gathered from a remote system and transmitted to the control system 56 via the network 61. However, in some embodiments, data may be transmitted directly from the measurement devices (e.g., the LWD modules 52, the MWD modules 54) to the control system 56. Indeed, the control system 56 may communicate with the devices directly and/or through the network 61 in accordance with present embodiments. In certain embodiments, measurement data may be automatically communicated to the control system 56 for analysis in real-time, thereby enabling real-time responses (e.g., controlling and adjusting the drilling system 10, etc.) to information obtained from analysis of the data. In some embodiments, the control system 56 may receive data from one or more databases 86.

The communication component 74 may be a wireless or wired communication component (e.g., circuitry) that may facilitate communication between the control system 56, various types of devices, the network 61, and the like. Additionally, the communication component 74 may facilitate data transfer to the control system 56, such that the control system 56 may receive data from the other components depicted in FIG. 1 and the like. The communication component 74 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 76 may include single-threaded processor(s), multi-threaded processor(s), or both. The processor 76 may process instructions stored in the memory 78. The processor 76 may also include hardware-based processor(s) each including one or more cores. The processor 76 may include general purpose processor(s), special purpose processor(s), or both. The processor 76 may be communicatively coupled to other internal components (such as the communication component 74, the data storage 80, the I/O ports 82, and the display 84).

The memory 78 and the data storage 80 may be any suitable articles of manufacture that can serve as media to store processor-executable code, data, or the like. These articles of manufacture may represent computer-readable media (e.g., any suitable form of memory or storage) that may store the processor-executable code used by the processor 76 to perform the presently disclosed techniques. As used herein, applications may include any suitable computer software or program that may be installed onto the control system 56 and executed by the processor 76. The memory 78 and the data storage 80 may represent non-transitory computer-readable media (e.g., any suitable form of memory or storage) that may store the processor-executable code used by the processor 76 to perform various techniques described herein. It should be noted that non-transitory merely indicates that the media is tangible and not a signal.

The I/O ports 82 may be interfaces that may couple to other peripheral components such as input devices (e.g., keyboard, mouse), sensors, input/output (I/O) modules, the tool bus 62 of the synchronization system 58, and the like. The display 84 may operate as a human machine interface (HMI) to depict visualizations associated with software or executable code being processed by the processor 76. The display 84 may display results and/or analyses based on downhole measurements, such as a map of the geological formation data (e.g., images and information derived from the images) corresponding to positions on the map, alerts/alarms when image data is not acceptable, recommendations associated with the alerts/alarms, synchronization information as discussed herein, etc. The display 84 may provide a visualization, a time synchronization interface, a well log, or other indication of properties of the synchronization system 58, the borehole 22 based on measurements of the LWD modules 52, the MWD modules 54, the timing modules 63, or a combination thereof. In one embodiment, the display 84 may be a touch display capable of receiving inputs from an operator of the control system 56. The display 84 may be any suitable type of display, such as a liquid crystal display (LCD), plasma display, or an organic light emitting diode (OLED) display, for example. Additionally, in one embodiment, the display 84 may be provided in conjunction with a touch-sensitive mechanism (e.g., a touch screen) that may function as part of a control interface for the control system 56.

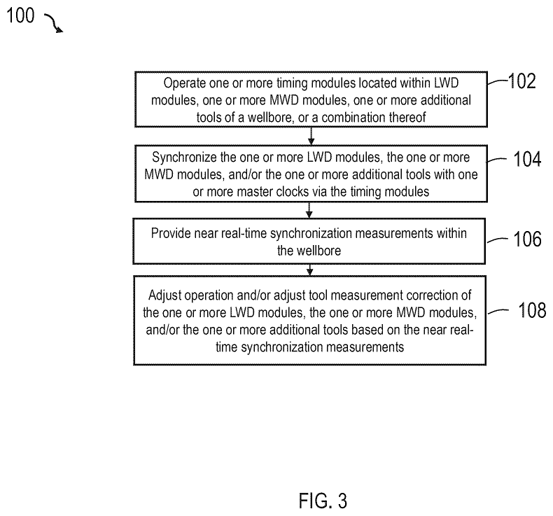

It should be noted that the components described above with regards to the synchronization system 58 and the control system 56 are exemplary components and may include additional or fewer components as shown. In addition, although the components are described as being part of the control system 56, the components may also be part of any suitable computing device described herein such as the LWD module 52, the MWD module 54, the control devices 72, and the like to perform the various operations described herein. FIG. 3 is a flow chart of an embodiment of a process 100 for providing near real-time synchronization measurements within a wellbore 22 and adjusting operation of a drilling system 10 based on time synchronization, accordance with the present disclosure. The process 100 may be performed by the synchronization system 58, the control system 56, the timing modules 63, or control devices 72 disclosed above with reference to FIG. 1 or any other suitable computing device(s) or controller(s). Furthermore, the blocks of the process 100 may be performed in the order disclosed herein or in any suitable order. For example, certain blocks of the process 100 may be performed concurrently or consecutively. In addition, in certain embodiments, at least one of the blocks of the process 100 may be omitted. Further, it should be noted, that the synchronization system 58 may iteratively perform the blocks outlined in process 100.

At block 102 of the process 100, the synchronization system 58 may operate one or more timing modules 63 located within one or more LWD modules 52, one or more MWD modules 54, one or more additional tools of a wellbore 22, or a combination thereof. In some embodiments, the timing modules 63 positioned within the more LWD modules 52, one or more MWD modules 54, one or more additional tools of a wellbore 22 may transmit timing signals between one or more master clocks 64 and one or more local clocks 66 positioned within components of the timing modules 63. For example, the timing modules 63 may facilitate inter-tool communication between an electromagnetic look-ahead-while-drilling (EMLA) device to detect formation features ahead of the drill bit 16 to optimize drill bit location and manage drill risks. The EMLA system may include a plurality of inter-tool buses that may be positioned on various LWD modules 52 and MWD modules 54. The inter-tool buses may be wired (e.g., connected) between tools within the BHA 51. The master clocks 64 and the local clocks 66 within the timing modules 63 of the LWD modules 52 and/or the MWD modules 54 may communicate with each other over the inter-tool bus. As such, the timing modules 63 may facilitate time synchronization between the inter-tool buses, the LWD modules 52 and the MWD modules 54. In this way, the timing modules 63 may be used to align antenna signal sampling for computation of resistivity measurement phase shifts. It should be noted, a master clock positioned downhole within a component of the BHA 51 may not connect to a satellite timing systems due to inability of high frequencies used in satellite positioning systems to penetrate the earth more than a few centimeters. As such, one or more sensors located on or near the drilling system 10 at a surface and connected via the network 61 may have a surface master clock. The surface master clock may be connected to timing from a satellite positioning system.

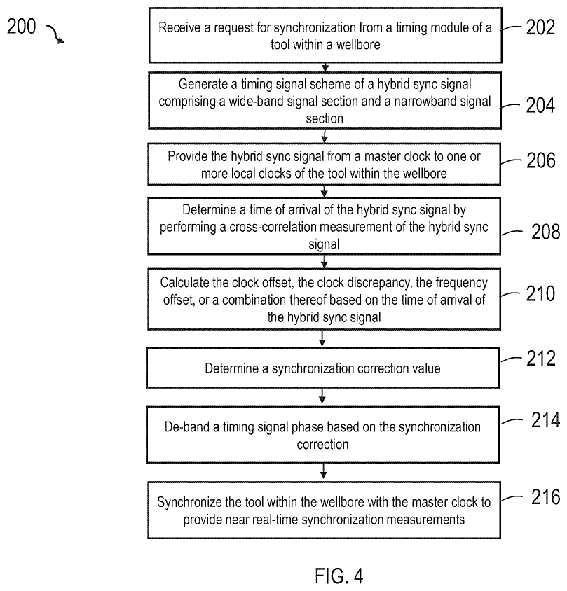

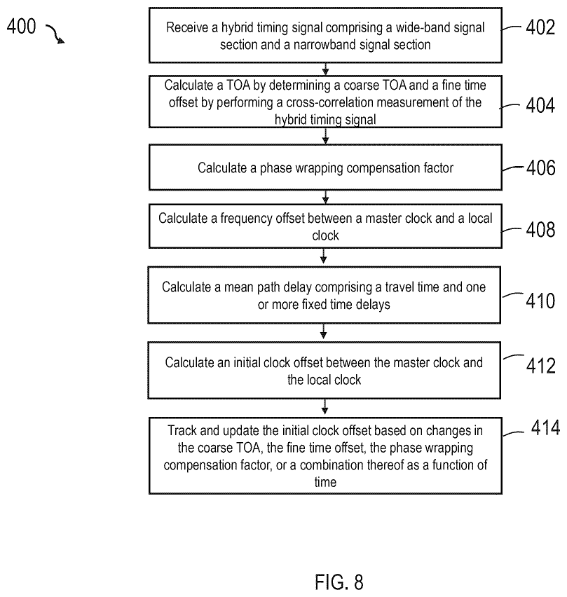

At block 104 of the process 100, the synchronization system 58 may synchronize the LWD modules 52, the MWD modules 54, and/or the additional tools with one or more master clocks 64 via the timing modules 63. The master clocks 64 may be located within the timing modules 63 of the downhole tool 12. Additionally and/or alternatively, the master clocks 64 may be located at an oil and gas work site (e.g., surface facility/control system) positioned to transmit signals, connect to the network 61, and/or additional suitable configurations. In some embodiments, the synchronization system 58 may perform synchronization as described in reference to FIG. 4 and FIG. 8 below. Briefly, the synchronization system 58 may generate a hybrid timing signal by modulating a wide-band timing section (e.g., a bi-phase modulated pseudo-random sequence signal) and a narrowband timing signal section (e.g., single-tone signal) onto a carrier wave. The wide-band timing signal section may provide the coarse TOA while reducing phase banding even in scenarios in which the hybrid timing signal may be distorted and/or include noise. The narrowband timing signal section may achieve high demodulation accuracy as compared to the wide-band signal section using the coarse TOA to generate a fine time offset. Using the coarse TOA and the fine time offset, the initial clock offset may be determined.

With this in mind, at block 106 of the process 100, the synchronization system 58 may provide near real-time synchronization measurement within the wellbore 22. Measurements generated by the LWD modules 52, the MWD modules 54, and/or the additional tools may be timestamped and may be used to inform drilling operations. As such, the near real-time synchronization may improve precision and/or accuracy of the measurements provided by the downhole tool 12. Continuing the example mentioned above, the EMLA may use the real-time synchronization measurements to provide time stamped resistivity measurement phase shifts. In some embodiments, one or more spaced apart sub-modules of the EMLA may be synchronized using SR-TOA measurements providing reliable data on a nanosecond timescale. As such, the synchronization system 58 may improve time synchronization of the EMLA improving efficiency of real-time drilling operations (e.g., real-time measurements and control of drilling equipment).

At block 108 of the process 100, the synchronization system 58 may adjust operation and/or adjust tool measurement correction of the LWD modules 52, the MWD modules 54, and/or the additional tools based on the near real-time synchronization measurements. For example, the near real-time synchronization measurements may provide accurate timestamps of measurement data to control a particular LWD module improving data quality acquired by the particular LWD module. Changes to the particular LWD module may be a result of clock drift within the particular LWD module based on changes in environmental factors such as temperature or pressure. Additionally and/or alternatively, the synchronization system 58 may adjust operation the BHA 51 (e.g., direction of rotary steerable system (RSS), rotational speed and weight on bit for the drill bit 16, flow rate of mud, etc.) based on data provided by the LWD modules 52, the MWD modules 54, and/or the additional tools. In this way, it may be advantageous to use the hybrid timing signal disclosed herein to increase drill bit control by improving precision and accuracy of signals provided by the downhole tools 12.

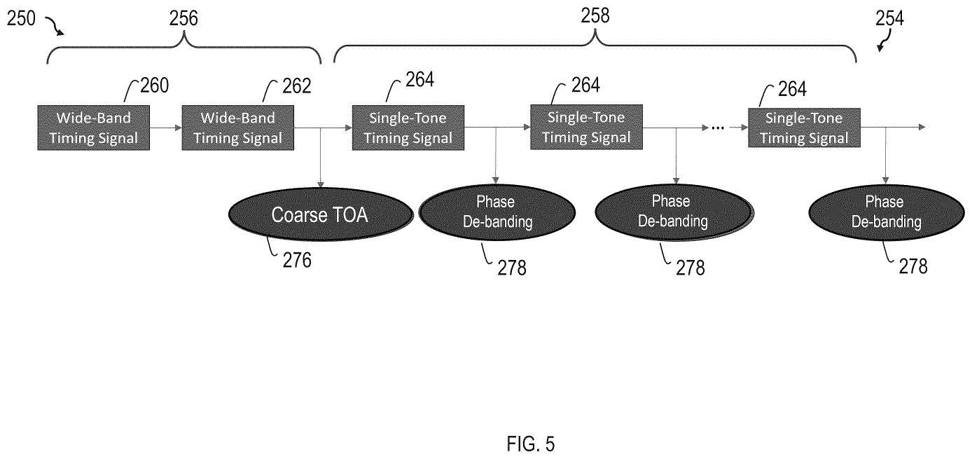

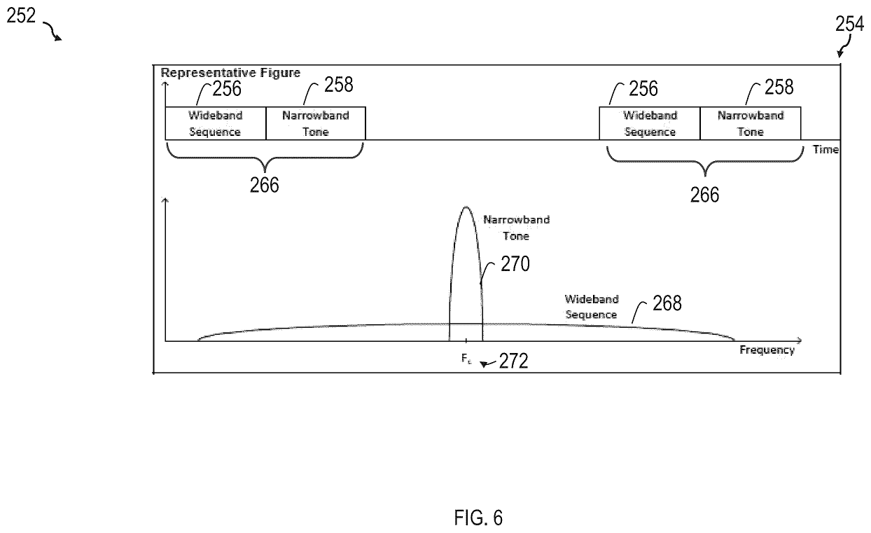

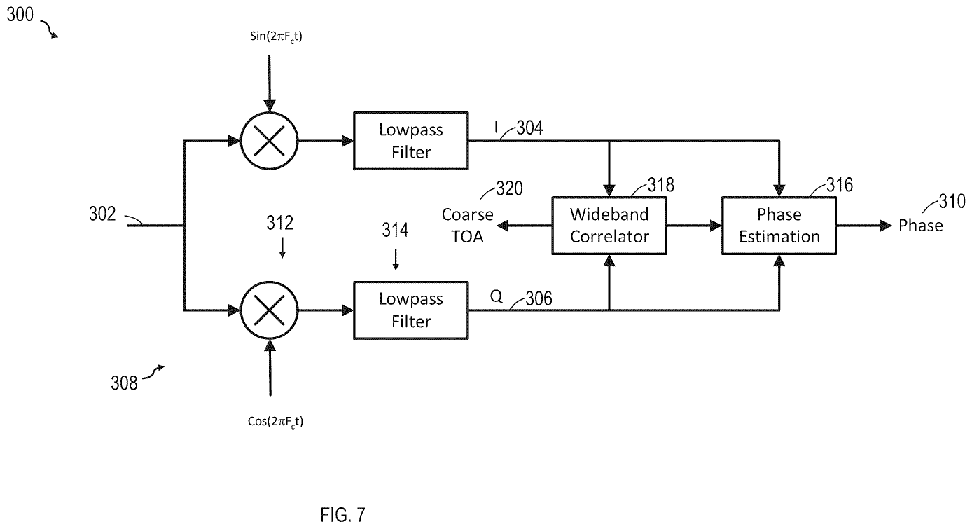

FIG. 4 is a flow chart of an embodiment of a process 200 for generating a hybrid timing signal and determining a synchronization correction between a master clock and one or more local clocks within a timing module 63, in accordance with the present disclosure. FIG. 5 illustrates a timing signal scheme including one or more signal bursts related to an embodiment of the hybrid timing signal, in accordance with the present disclosure. FIG. 6 illustrates a timing signal scheme including one or more hybrid timing signal bursts in the time domain and the frequency domain, in accordance with the present disclosure. FIG. 7 illustrates a method of generating a fine timing estimate of a TOA by estimating the phase of a narrowband signal section of the hybrid timing signal. To facilitate discussion, FIGS. 4-7 will be discussed below concurrently. It should be noted that the process 200 is not limiting, and the synchronization system 58 and/or the process 200 may include additional or fewer steps than those illustrated. Further, the synchronization system 58 and/or process 200 may include steps that are performed in an alternative order to that illustrated in process 200. That is, certain steps may be performed before, after, or concurrently to/with another respective step.

At block 202 of the process 200 of FIG. 4, the synchronization system 58 may receive a request for synchronization from a timing module 63 (e.g., master clock 64, local clock 66, oscillator 70) of a tool (e.g., downhole tool 12) within a wellbore 22. The request may be based on an end-to-end measurement mode, a peer-to-peer measurement mode, or one or more measurement mode. For example, in the end-to-end measurement mode each local clock may send a request to a master clock. As such, a sampling frequency of the master clock may be limited by a number of local clocks sending requests for synchronization. In some embodiments, the peer-to-peer measurement mode may be used to request time synchronization between local devices attached to one another. That is, the request may be sent to the master clock from various local clocks in series.

At block 204 of the process 200, the synchronization system 58 may generate a timing signal scheme 250, 252 of a hybrid sync signal 254 (e.g., a hybrid timing signal) comprising a wide-band signal section 256 and a narrowband signal section 258 as shown in FIG. 5 and FIG. 6. It should be noted, the timing signal scheme 250, 252 may be repeated a plurality of times and/or modulated on a carrier wave in different intervals. In some embodiments, the timing signal scheme 250 of the hybrid sync signal 254 may include a first wide-band timing signal 260 and a second wide-band timing signal 262 followed by a series of single-tone timing signals 264. In other embodiments, the timing signal scheme 252 may include a paired timing signal 266 comprising the wide-band signal section 256 and a narrowband signal section 258. In some instances, the narrowband signal section 258 may include a single-tone timing signal 264. It should be noted that the timing signal schemes 250, 252 described herein are non-limiting embodiments and one or more additional timing signal schemes may be envisioned within the systems and methods disclosed herein. For example, an additional timing signal scheme may include the paired timing signal 266 followed by a series of single-tone timing signals 264. Additionally and/or alternatively, the timing signal schemes may repeat following a predetermined amount of cycles. In this manner, the hybrid timing signal 254 may be transmitted by the timing modules 63.

At block 206 of the process 200, the synchronization system 58 may provide the hybrid sync signal 254 from a master clock 64 to one or more local clocks 66 of the tools within the wellbore 22. In certain embodiments, the timing modules 63 may send the hybrid sync signal 254 from the master clock 64 to a first local clock. In some instances, the hybrid sync signal 254 may be sent for a set number of times from the master clock 64 to the first local clock. In some embodiments, the master clock 64 may send the hybrid sync signal 254 from a clock edge of the master clock 64 to the first local clock. The first local clock may receive the hybrid sync signal 254 modulated on the carrier wave. The first local clock may be used to determine a TOA of the hybrid sync signal 254. FIG. 6 illustrates relative bandwidths in the frequency domain of the wide-band signal section 256 and the narrowband signal section 258 of the hybrid timing signal 254. in the frequency domain, the hybrid sync signal 254 may include a wide-band spectrum 268 and a narrowband spectrum 270. The power spectral density of the wide-band spectrum 268 and the narrowband spectrum 270 of the hybrid timing signal 254 are illustrated. In some embodiments, a power of the wide-band signal section 256 and the narrowband signal section 258 of the hybrid timing signal 254 may be determined by calculating the area under the curve (e.g., the integral of the wide-band spectrum 268 and the narrowband spectrum 270. The amplitude of the wide-band spectrum 268 and the narrowband spectrum 270 of the hybrid timing signal 254 may be the same. However, it should be noted, in some instances the amplitude of the wide-band spectrum 268 and the narrowband spectrum 270 may differ. A peak amplitude may be determined as shown by a frequency 272 (e.g., F_{c}) in FIG. 6. The received hybrid sync signal 254 may be used to determine the TOA using cross-correlation measurements and phase estimates.

At block 208 of the process 200, the synchronization system 58 may determine a time of arrival of the hybrid sync signal 254 at the master clock 64 and/or the local clocks 66 by performing a cross-correlation measurement of the hybrid sync signal 254. The cross-correlation measurement may be performed by comparing the hybrid sync signal 254 with a reference signal. For example, a wide-band cross-correlation measurement may be generated using the received hybrid sync signal 254 and a wide-band reference signal. The wide-band cross-correlation measurement may provide a time-domain correlation of the wide-band signal section 256 of the hybrid sync signal. The wide-band cross-correlation measurement may produce a narrow magnitude correlation peak in the time domain. The correlation peak of the wide-band cross-correlation measurement may provide a coarse TOA 276 of the hybrid sync signal 254.

In some embodiments, a fine timing estimate of the TOA may be determined by estimating the phase of the narrowband signal section. As shown by a method 300 illustrated in FIG. 7, the phase estimate may be generated by splitting a received hybrid timing signal 302 into an in-phase (I) 304 and a quadrature (Q) component 306 of the received hybrid timing signal 302 via a Hilbert transform 308. Additionally and/or alternatively, as shown in FIG. 7 a phase 310 may be generated by splitting the received hybrid timing signal into an in-phase/quadrature 312 mixer followed by one or more lowpass filtering steps 314 and a phase estimation step 316. In some embodiments, a wide-band correlator step 318 may be performed to generate a coarse TOA 320. In the absence of a frequency offset between a transmission clock and one or more receiver clocks, the I component 304 and the Q component 306 of the narrowband signal section may remain constant for a duration of the narrowband signal section. As such, averaging the I component 304 and the Q component 306 over the duration of the narrowband tone may reduce effects of noise. In some embodiments, a four-quadrant arctangent estimate (e.g., arctan(Q/I)) may provide the phase 310 and the fine time offset may be extracted from the phase estimate.

At block 210 of the process 200, the synchronization system 58 may calculate the clock offset, the frequency offset (e.g., relative clock offset), or a combination thereof based on the time of arrival at the master clock 64 and/or the local clocks 66. The clock offset may be calculated as outlined by Equation 1,

$$Offset = {SYNC}_{T} - {SYNC}_{R} \qquad Equation 1$$

wherein, SYNC_{T} is a transmittance time of the hybrid sync signal 254 and SYNC_{R} is a received time of the hybrid sync signal 254 at the local clock. In some embodiments, the frequency offset may be calculated by measuring elapsed time differences between two synchronization events (e.g., two transmittance/receivals of the hybrid sync signal 254) as outline by Equation 2,

$${K}_{ppb} = ( 1 - Δ {SYNC}_{R} / Δ {SYNC}_{T} ) \cdot {10}^{9} \qquad Equation 2$$

wherein K_{ppb} is the frequency offset in ppb and ΔSYNC_{R} is SYNC_{R}−SYNC_{R-1} and ΔSYNC_{T} is SYNC_{T}−SYNC_{T-1}. Calculation of the frequency offset will be further discussed in regards to FIG. 8 and Equation 6 described below.

At block 212 of the process 200, the synchronization system 58 may determine a synchronization correction value. The synchronization correction value may include a value that may be used to align the local clocks 66 to the master clock 64. At block 214 of the process 200, the timing modules 63 may demodulate a timing signal phase based on the synchronization correction. In some embodiments, demodulating of the timing signal phase may restore data from the hybrid sync signal 254 from the carrier wave. That is, demodulation may recover a baseband synchronization sequence from a modulated carrier wave. It should be noted that blocks 202 through 214 may be performed continuously to update the synchronization correction value to improve alignment of the master clock 64 and the local clocks 66. At block 216 of the process 200, the synchronization system 58 may synchronize the tool within the wellbore with the master clock to provide near real-time synchronization measurements. In some embodiments, synchronization of the tool within the wellbore may improve precision and accuracy of real-time changes in measurements to control the drilling system 10. It should be noted that blocks 202 through 216 may be performed continuously to update the synchronization correction value to improve alignment of the master clock 64 and the local clocks 66 and improve synchronization of the tool within the wellbore.

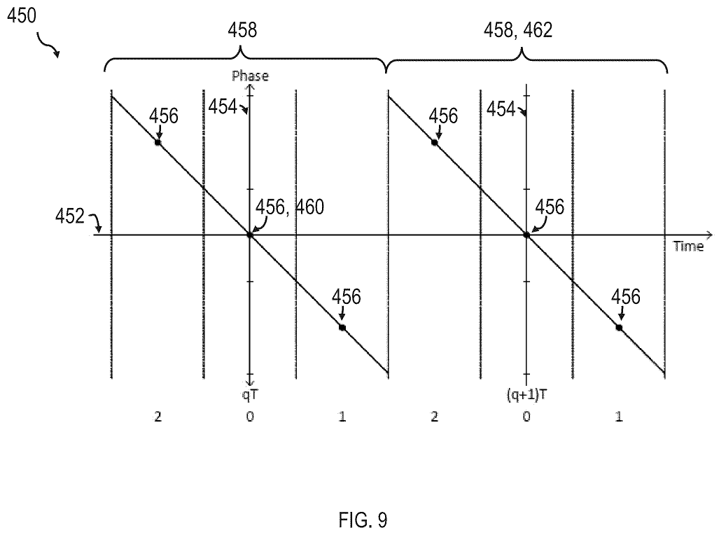

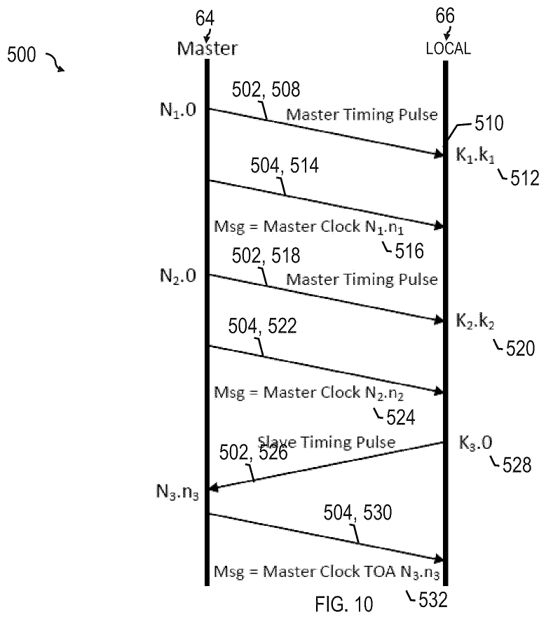

FIG. 8 is a flow chart of a computer-implemented method or process 400 for calculating an initial clock offset between a master clock and a local clock, in accordance with the present disclosure. FIG. 9 illustrates a graph 450 of phase versus time offset for a sinusoidal tone with three samples per carrier cycle, in accordance with the present disclosure. FIG. 10 illustrates a precision time protocol 500 including a plurality of timing pulses 502 and a plurality of message passings 504, in accordance with the present disclosure. To facilitate discussion, FIGS. 8-10 will be discussed below concurrently. It should be noted that the process 400 is not limiting, and the synchronization system 58 and/or the process 400 may include additional or fewer steps than those illustrated. Further, the synchronization system 58 and/or process 400 may include steps that are performed in an alternative order to that illustrated in process 400. That is, certain steps may be performed before, after, or concurrently to/with another respective step.

At block 402 of the process 400 of FIG. 8, the synchronization system 58 may receive a hybrid timing signal 254 comprising a wide-band signal section 256 and a narrowband signal section 258 at a timing module 63. In some embodiments, the hybrid timing signal 254 may include a repeating series of the paired timing signals 266. As such, the wide-band signal section 256 and a narrowband signal section 258 may repeat in a predetermined number of tone cycles. In certain embodiments, the narrowband signal section 258 may begin an integer number of tone cycles after a correlation peak of the wide-band signal section 256. In this manner, the paired timing signal 266 may be used in combination to determine a TOA of the hybrid timing signal 254 at one or more clocks (e.g., master clock 64, local clocks 66, or a combination thereof).

At block 404 of the process 400, the synchronization system 58 may calculate a TOA by determining a coarse TOA 276 and a fine time offset by performing a cross-correlation measurement the hybrid timing signal 254. The TOA may be calculated as outlined by Equations 3-5. q is the integer number of complete sine wave cycles as represented by Equation 3,

$$q = int ( \frac{{P}_{c}}{n} ) \qquad Equation 3$$

wherein, P_{c} is the sample number at the start of the narrowband signal section 258 as calculated from the correlation peak of the wideband signal section 256 plus a predetermined number of cycles after at which a phase estimate, φ, is calculated. n is the number of samples per cycle of the narrowband signal section 258. The TOA is represented by Equation 4 and Equation 5,

$$TOA = Coarse TOA + Fine Time Offset \qquad Equation 4$$

$$TOA = qT + dt = \frac{1}{{F}_{c}} ( q - \frac{φ}{2 π} ) \qquad Equation 5$$

wherein, q is the integer number of complete sine wave cycles as represented by Equation 3, T is the period of one cycle of the narrowband signal section of frequency F_{c}, φ is the phase estimate calculated at a correlation peak plus the predetermined number of cycles, r is the modulo-n residual sample offset,

$$mod ( \frac{{P}_{c}}{n} ) ,$$

and dt is the fine time offset. As shown, the narrowband signal section 258 is assumed to start at an integer number of cycles after the correlation peak of the wide-band signal section 256. It should be noted, a non-integer number of cycles may be used.

At block 406 of the process 400, the synchronization system 58 may calculate a phase wrapping compensation factor. In some embodiments, the synchronization system 58 may determine the phase wrapping compensation factor is needed in calculating the TOA. For example, the graph 450 of FIG. 9 illustrates time offset 452 versus phase 454 for a sinusoidal tone with one or more samples 456 (e.g., n=3 illustrated) per each carrier cycle 458. In some embodiments, phase wrapping may occur and the phase wrapping compensation factor may be calculated and considered in regards to Equation 4 and Equation 5. For example, when n is 3, as shown, if r is 0, as illustrated by a first sample point 456, 460 no phase wrapping compensation factor is included, that is the phase wrapping compensation factor is zero. In some embodiments, if r is 1 and φ greater than

$$\frac{π}{3}$$

then the phase wrapping compensation factor is one and, q is q+1 as the fine time offset is relative to a subsequent carrier cycle 458, 462. In certain embodiments, if r is 2 and φ is greater than

$$- \frac{π}{3} ,$$

the phase wrapping compensation factor is one and q=q+1. It should be noted that FIG. 9 is a non-limiting embodiment and one or more additional carrier cycles are envisioned with one or more additional samples at integer and/or non-integer values. In some embodiments, calculation of the TOA may be used as a part of a precision time protocol 500 (e.g., IEEE 1588, CERN White Rabbit, and the like) to achieve absolute time synchronization between free running remote clocks (e.g., master clocks 64, local clocks 66).

The precision time protocol 500 of FIG. 10 includes a plurality of timing pulses 502 of the hybrid timing signal 254 (e.g., hybrid sync signal) and a plurality of message passings 504. A master clock 64 may record (e.g., timestamp) a first clock cycle 510 (e.g., N1.0) on a local clock 66. A first master timing pulse 508 (e.g., the hybrid timing signal 254 transmitted from the master clock 64) may be sent to the local clock 66. The local clock 66 may estimate an arrival time of the first master timing pulse 508 and record the arrival time relative to a second clock cycle on the local clock 66. As shown, a timestamp 512 of the first master timing pulse 508 may be in an integer.fraction form (e.g., K₁.k₁).

In certain embodiments, the master clock 64 may send a first message passing 514 to the local clock 66 informing the local clock 66 of transmission of a timestamp 516 of the first master timing pulse 508. In some embodiments, a second master timing pulse 518 may be sent from the master clock 64 a later time (e.g., a third clock cycle 520, N2.0). Sending the second master timing pulse 518 at the later time may enable calculation of a relative clock frequency difference between the master clock 64 and the local clock 66. In some embodiments, an estimated arrival time of the second master timing pulse 518 at the local clock 66 is determined. For example, the local clock 66 may estimate an arrival time of the second master timing pulse 518 and record the arrival time on the local clock 66. As shown, a timestamp 520 of the second clock cycle may be in an integer.fraction form (e.g., K₂.k₂). In certain embodiments, the master clock 64 may send a second message passing 522 to the local clock 66 informing the local clock 66 of transmission of a timestamp 524 of the third master timing pulse 522. The frequency offset, df, may be calculated using the determined timestamps 512, 516, 520, 524.

With this in mind, at block 408 of the process 400, the synchronization system 58 may calculate a frequency offset between a master clock 64 and a local clock 66. Calculation of the frequency offset may be represented by Equation 6,

$$1 + df = \frac{{K}_{2} \cdot {k}_{2} - {K}_{1} \cdot {k}_{1}}{{N}_{2} - {N}_{1}} \qquad Equation 6$$

wherein K₂.k₂ is the timestamp 520 of the second master timing pulse 518, K₁.k₁ is the timestamp 512 of the first master timing pulse 508, N₂ is the timestamp 524, and N₁ is the timestamp 516.

At block 410 of the process 400, the synchronization system 58 may calculate a mean path delay comprising a travel time and one or more fixed time delays. In some embodiments, the one or more fixed time delays may be based on travel time through electronics, one or more signal processing steps, and the like. For example, the mean path delay may include estimates of local processing time delays. In this way, the mean path delay may loop back a transmitted signal (e.g., hybrid timing signal 254) into a receiver of a designated modem of the same timing module. To calculate the mean path delay, the local clock 66 may send a local timing pulse 526 from the local clock 66 to the master clock 64 at a timestamp 528 (e.g., K₃.0). The master clock 64 may send a third message passing 530 to the local clock 66 upon receival of the local timing pulse 526. The third message passing 530 may inform the local clock 66 of the time of arrival of the local timing pulse 526 at the master clock 64 via a timestamp 532 of the local timing pulse 526 (e.g., N₃.n₃). The mean path delay may be calculated as represented by Equation 7,

$$Mean Path Delay = \frac{1}{2} [ {N}_{3} \cdot {n}_{3} - \frac{{K}_{3}}{( 1 + df )} + \{ \frac{{K}_{2} \cdot {k}_{2}}{( 1 + df )} - {N}_{2} \} ] \qquad Equation 7$$

wherein K₂.k₂ is the timestamp 520 of the second master timing pulse 518, K₃ is the timestamp 528 of sending the local timing pulse 526, N₂ is the timestamp 524, and N₃ is the timestamp 532.

At block 412 of the process 400, the synchronization system 58 may calculate an initial clock offset between the master clock 64 and the local clock 66. The initial clock offset may be calculated as represented by Equation 8.

$$Initial Clock Offset = \frac{{K}_{2} \cdot {k}_{2}}{( 1 + df )} - {N}_{2} - Mean Path Delay \qquad Equation 8$$

In some embodiments, the initial clock offset may provide the absolute clock offset of the master clock 64 and the local clock 66 with super-resolution (e.g., higher resolution than one sample period, nanosecond range).

At block 414 of the process 400, the synchronization system 58 may track and update the initial clock offset based on changes in the coarse TOA 276, the fine time offset, the phase wrapping compensation factor, or a combination thereof, as a function of time. In some embodiments, calculation of the initial clock offset may be performed continuously to update and improve alignment of the master clock 64 and the local clocks 66. It may be advantageous to track and update the initial clock offset of the master clocks 64 and the local clocks 66 operated within the drilling system 10 as the environmental conditions may cause clock drift due to changes in character of the oscillators 70 and/or additional factors such as changes in noise of the carrier wave, and the like.

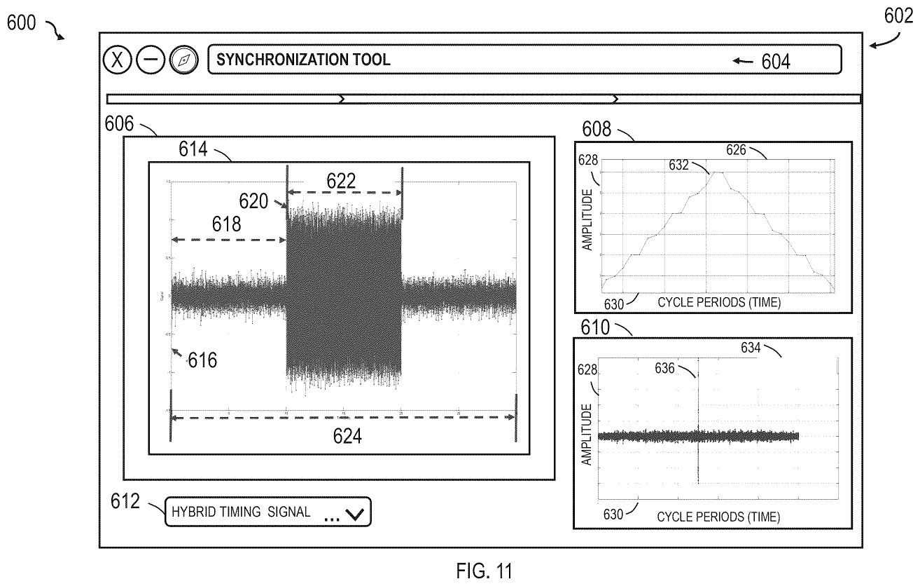

FIG. 11 is an embodiment of a user interface 600 of synchronization system 58, wherein the user interface 600 is disposed on an electronic device (e.g., computer display), in accordance with the present disclosure. The user interface 600 may display a screen 602 having a dashboard 604 of the synchronization system 58. The dashboard 604 may include various windows (e.g., user interface widgets) prompting the user for inputs, providing notifications, outputting time synchronization data, and the like. For example, the various windows may include a timing burst window 606, a narrowband window 608, a wide-band window 610, and the like. The user interface 600 may allow a user to select, view, and/or manage one or more windows deployed by the synchronization system 58. It should be noted that one or more additional windows may be displayed via the screen 602. For example, the user may select one or more inputs in a parameter field 612 to display the additional windows. It should be noted, the user interface 600 may be used in development and/or surface testing of the synchronization system 58 and may not be available during operation of the timing modules 63 during operation with the BHA 51.

As shown, the timing burst window 606 displays a timing signal burst 614 as a function of time. The timing signal burst 614 may display an analog-to-digital (ADC) start time 616, a relative TOA to ADC start time 618, a sync time 620, a sync signal 622, an ADC sampling range 624, and one or more additional features of the timing signal burst 614. The user may select, view, and/or manage measurements and/or analysis of the timing signal burst 614 via the user interface 600. The narrowband window 608 displays a graph 626 of amplitude 628 versus time 630 of the correlation magnitude of the narrowband signal section 258 with a wide peak 632. The wide-band window 610 displays a graph 634 of amplitude 628 versus time 630 of the wide-band signal section 256 of the hybrid timing signal 254. The magnitude peak has a sharp peak 636 and, as described above, is used to determine the coarse TOA estimation. The fine timing offset may be obtained from the phase of the narrowband signal section 258.

Technical effects of the disclosed techniques include use of a synchronization system 58 to provide time synchronization to various BHA components such as LWD modules, MWD modules, and/or other components of a drilling system. As such, one or more timing modules may be positioned within the LWD modules, MWD modules, and/or other components of the BHA. The timing modules may be connected to a tool bus, a network, or a combination thereof. The timing modules may generate a hybrid timing signal comprising a wide-band signal section and a narrowband signal section to provide super-resolution synchronization of master clocks and local clocks. The synchronization system 58 may improve precision and accuracy associated with aligning clocks of the drilling system. Further, use of the hybrid signal may enable use of the wide-band timing section to determine a coarse TOA. As such, phase-banding of timing signals may be reduced as compared to using single-tone signals. Use of the narrowband signal section to determine the fine time offset may improve TOA detection by using the coarse TOA estimate to reduce impacts from phase-banding. Improvement in time synchronization may provide improved efficiency and performance of controlling downhole tools of the drilling system by offering absolute time offsets of data collected in geological environments.

The subject matter described in detail above may be defined by one or more clauses, as set forth below.

A method including transmitting the hybrid timing signal, via a master clock, to the local clock of the tool, wherein the hybrid timing signal comprises one or more wide-band signal sections and one or more narrowband signal sections. The method also includes calculating an initial clock offset between the local clock of the tool and the master clock, based on a difference in the time of arrival and the hybrid timing signal at the local clock and a time of transmission of the hybrid timing signal and synchronizing the tool based on the initial clock offset.

The method of the preceding clause, further including determining the time of arrival of the hybrid timing signal at the local clock based on a cross-correlation and a phase estimate, wherein the cross-correlation is generated between the wide-band signal section of the hybrid timing signal and a reference signal and determining a mean path delay of the hybrid timing signal.

The method of any of the preceding clauses, further including demodulating the hybrid timing signal based on the initial clock offset and synchronizing the local clock of the tool with the master clock to provide near real-time measurements.

The method of any of the preceding clauses, wherein the mean path delay comprises a time delay based on a travel time of the hybrid timing signal and one or more fixed time delays within the tool.

The method of any of the preceding clauses, further including determining a coarse time of arrival of the hybrid timing signal, wherein the coarse time of arrival is calculated by performing a cross-correlation measurement of the one or more wide-band signal sections of the hybrid timing signal and a wide-band reference signal.

The method of the preceding clauses, wherein the coarse time of arrival is within one cycle of a center frequency of the hybrid timing signal.

The method of any of the preceding clauses, further including determining a fine time offset of the hybrid timing signal, wherein the fine time offset is calculated by performing a cross-correlation, performing Hilber transform, or using an in-phase quadrature mixture.

The method of any of the preceding clauses, including calculating a frequency offset between a first master signal burst and a second master signal burst, wherein the first master signal burst and the second master signal burst are sent from the master clock to the local clock of the tool, and wherein the second master signal burst is sent at a time later than a time the first master signal burst is sent.

The method of the preceding clause, further comprising determining a mean path delay of the hybrid timing signal, wherein the mean path delay comprises one or more estimates of local processing time delays

A non-transitory, computer-readable storage medium, comprising processor-executable routines that, when executed by a processor, cause the processor to perform operations. The processor performs operations including transmitting the hybrid timing signal, via a master clock, to the local clock of the tool, wherein the hybrid timing signal comprises one or more wide-band signal sections and one or more narrowband signal sections. The operations also include determining a time of arrival of the hybrid timing signal at the local clock based on a cross-correlation and a phase estimate, wherein the cross-correlation is generated between the wide-band signal section of the hybrid timing signal and a reference signal, determining a mean path delay of the hybrid timing signal, calculating an initial clock offset between the local clock of the tool and the master clock, based on a difference in the time of arrival and the hybrid timing signal at the local clock and a time of transmission of the hybrid timing signal and synchronizing the tool based on the initial clock offset.

The non-transitory, computer-readable storage medium of the preceding clause, further including demodulating the hybrid timing signal based on the initial clock offset and synchronizing the local clock of the tool with the master clock to provide near real-time measurements.

The non-transitory, computer-readable storage medium of any of the preceding clauses, further including determining a coarse time of arrival of the hybrid timing signal, wherein the coarse time of arrival is calculated by performing a cross-correlation measurement of the one or more wide-band signal sections of the hybrid timing signal and a wide-band reference signal, wherein the coarse time of arrival is within one cycle of a center frequency of the hybrid timing signal.

The non-transitory, computer-readable storage medium of any of the preceding clauses, further including determining a fine time offset of the hybrid timing signal, wherein the fine time offset is calculated by performing a cross-correlation, performing Hilber transform, or using an in-phase quadrature mixture. The non-transitory, computer-readable storage medium of any of the preceding clauses, further including calculating a frequency offset between a first master signal burst and a second master signal burst, wherein the first master signal burst and the second master signal burst are sent from the master clock to the local clock of the tool, and wherein the second master signal burst is sent at a time later than a time the first master signal burst is sent, wherein the time later may comprise a predetermined number of cycles.

The non-transitory, computer-readable storage medium of any of the preceding clauses, further including wherein the mean path delay comprises a time delay based on a travel time of the hybrid timing signal and one or more fixed time delays within the tool.

A system is provided including processing circuitry and memory, accessible by the processing circuitry, the memory storing instructions that, when executed by the processing circuitry, cause the processing circuitry to perform operations. The operations include transmitting the hybrid timing signal, via a master clock, to the local clock of the tool, wherein the hybrid timing signal comprises one or more wide-band signal sections and one or more narrowband signal sections. The operation also includes calculating an initial clock offset between the local clock of the tool and the master clock, based on a difference in the time of arrival and the hybrid timing signal at the local clock and a time of transmission of the hybrid timing signal and synchronizing the tool based on the initial clock offset.

The system of the preceding clause, wherein the processing circuitry performs operations including the time of arrival of the hybrid timing signal at the local clock based on a cross-correlation and a phase estimate, wherein the cross-correlation is generated between the wide-band signal section of the hybrid timing signal and a reference signal and determining a mean path delay of the hybrid timing signal.

The system of any of the preceding clauses, wherein the processing circuitry performs operations including demodulating the hybrid timing signal based on the initial clock offset and synchronizing the local clock of the tool with the master clock to provide near real-time measurements.

The system of any of the preceding clauses, wherein the mean path delay comprises a time delay based on a travel time of the hybrid timing signal and one or more fixed time delays within the tool.

The system of any of the preceding clauses, wherein the processing circuitry performs operations includes determining a coarse time of arrival of the hybrid timing signal at the local clock, wherein the coarse time of arrival is calculated by performing a cross-correlation measurement of the one or more wide-band signal sections of the hybrid timing signal and a wide-band reference signal and determining a fine time offset of the hybrid timing signal, wherein the fine time offset is calculated by estimating a phase of the narrowband signal section by splitting the received hybrid timing signal into an in-phase (I) and a quadrature (Q) component using a Hilbert transform.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
transmitting a hybrid timing signal, via a master clock, to a local clock of the tool, wherein the hybrid timing signal comprises one or more wide-band signal sections and one or more narrowband signal sections;
calculating an initial clock offset between the local clock of the tool and the master clock based on a difference in a time of arrival of the hybrid timing signal at the local clock and a time of transmission of the hybrid timing signal; and
synchronizing the tool based on the initial clock offset.

2. The method of claim 1, further comprising:
determining the time of arrival of the hybrid timing signal at the local clock based on a cross-correlation and a phase estimate, wherein the cross-correlation is generated between the wide-band signal section the hybrid timing signal and a reference signal; and
determining a mean path delay of the hybrid timing signal.

3. The method of claim 2, further comprising:
demodulating the hybrid timing signal based on the initial clock offset; and
synchronizing the local clock of the tool with the master clock to provide near real-time measurements.

4. The method of claim 2, wherein the mean path delay comprises a time delay based on a travel time of the hybrid timing signal and one or more fixed time delays within the tool.

5. The method of claim 1, further comprising:
determining a coarse time of arrival of the hybrid timing signal, wherein the coarse time of arrival is calculated by performing a cross-correlation measurement of the one or more wide-band signal sections of the hybrid timing signal and a wide-band reference signal.

6. The method of claim 5, wherein the coarse time of arrival is within one cycle of a center frequency of the hybrid timing signal.

7. The method of claim 1, further comprising:
determining a fine time offset of the hybrid timing signal, wherein the fine time offset is calculated by performing a cross-correlation, performing Hilber transform, or using an in-phase quadrature mixture.

8. The method of claim 1, further comprising:
calculating a frequency offset between a first master signal burst and a second master signal burst, wherein the first master signal burst and the second master signal burst are sent from the master clock to the local clock of the tool, and wherein the second master signal burst is sent at a time later than a time the first master signal burst is sent.

9. The method of claim 8, further comprising:
determining a mean path delay of the hybrid timing signal, wherein the mean path delay comprises one or more estimates of local processing time delays.

10. A non-transitory, computer-readable storage medium, comprising processor-executable routines that, when executed by a processor, cause the processor to perform operations comprising:
transmitting a hybrid timing signal, via a master clock, to a local clock of the tool, wherein the hybrid timing signal comprises one or more wide-band signal sections and one or more narrowband signal sections;
determining a time of arrival of the hybrid timing signal at the local clock based on a cross-correlation and a phase estimate, wherein the cross-correlation is generated between the wide-band signal section of the hybrid timing signal and a reference signal;
determining a mean path delay of the hybrid timing signal;
calculating an initial clock offset between the local clock of the tool and the master clock based on a difference in the time of arrival of the hybrid timing signal at the local clock and a time of transmission of the hybrid timing signal; and
synchronizing the tool based on the initial clock offset.

11. The non-transitory, computer-readable storage medium of claim 10, further comprising:
demodulating the hybrid timing signal based on the initial clock offset; and
synchronizing the local clock of the tool with the master clock to provide near real-time measurements.

12. The non-transitory, computer-readable storage medium of claim 10, further comprising:
determining a coarse time of arrival of the hybrid timing signal, wherein the coarse time of arrival is calculated by performing a cross-correlation measurement of the one or more wide-band signal sections of the hybrid timing signal and a wide-band reference signal, wherein the coarse time of arrival is within one cycle of a center frequency of the hybrid timing signal.

13. The non-transitory, computer-readable storage medium of claim 10, further comprising:
determining a fine time offset of the hybrid timing signal, wherein the fine time offset is calculated by performing a cross-correlation, performing Hilber transform, or using an in-phase quadrature mixture.

14. The non-transitory, computer-readable storage medium of claim 10, further comprising:
calculating a frequency offset between a first master signal burst and a second master signal burst, wherein the first master signal burst and the second master signal burst are sent from the master clock to the local clock of the tool, and wherein the second master signal burst is sent at a time later than a time the first master signal burst is sent, wherein the time later may comprise a predetermined number of cycles.

15. The non-transitory, computer-readable storage medium of claim 10, wherein the mean path delay comprises a time delay based on a travel time of the hybrid timing signal and one or more fixed time delays within the tool.

16. A system, comprising:
processing circuitry; and
memory, accessible by the processing circuitry, the memory storing instructions that, when executed by the processing circuitry, cause the processing circuitry to perform operations comprising:
transmitting a hybrid timing signal, via a master clock, to a local clock of the tool, wherein the hybrid timing signal comprises one or more wide-band signal sections and one or more narrowband signal sections;
calculating an initial clock offset between the local clock of the tool and the master clock based on a difference in a time of arrival of the hybrid timing signal at the local clock and a time of transmission of the hybrid timing signal; and
synchronizing the tool based on the initial clock offset.

17. The system of claim 16, wherein the processing circuitry performs operations comprising:
determining the time of arrival of the hybrid timing signal at the local clock based on a cross-correlation and a phase estimate, wherein the cross-correlation is generated between the wide-band signal section of the hybrid timing signal and a reference signal; and
determining a mean path delay of the hybrid timing signal.

18. The system of claim 17, wherein the processing circuitry performs operations comprising:
demodulating the hybrid timing signal based on the initial clock offset; and
synchronizing the local clock of the tool with the master clock to provide near real-time measurements.

19. The system of claim 17, wherein the mean path delay comprises a time delay based on a travel time of the hybrid timing signal and one or more fixed time delays within the tool.

20. The system of claim 16, wherein the processing circuitry performs operations comprising:
determining a coarse time of arrival of the hybrid timing signal at the local clock, wherein the coarse time of arrival is calculated by performing a cross-correlation measurement of the one or more wide-band signal sections of the hybrid timing signal and a wide-band reference signal; and
determining a fine time offset of the hybrid timing signal, wherein the fine time offset is calculated by wherein the coarse time of arrival is within one cycle of a center frequency of the hybrid timing signal.
